(19) United States
(12) Patent Application Publication
(10) Pub. No.: US 2002/0076035 A1
(43) Pub. Date: Jun. 20, 2002

(54) Passive DSL splitting

(76) Inventor: Robert D. Wachel, Altadena, CA (US)

Correspondence Address: Charles K. Young, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/737,999

(22) Filed: Dec. 14, 2000

(51) Int. Cl. H04M 1/00; H04M 9/00

(52) U.S. Cl. 379/399.01

(57) ABSTRACT

A method of providing digital subscriber line (“DSL”) service and plain old telephone service (“POTS”) in a chassis. A communication I/O line is connected to the chassis. A first circuit board provides the DSL service. A second circuit board provides POTS.

### BACKGROUND OF THE INVENTION

1. Field of the Invention

The described invention relates to the field of network communications. In particular, the invention relates to providing digital subscriber line (DSL) service and plain old telephone service (POTS).

2. Description of Related Art

Digital subscriber line service allows high frequency data to be sent on the same line as POTS. FIG. 1 shows a prior art setup between a telephone central office and a consumer's home. A DSL transmitter 10 is coupled to a splitter 12 in the central office to provide the high frequency signals from the central office.

At the consumer's home, a splitter 22 splits out the DSL signals to a DSL modem 24 from which the data is typically coupled to a consumer's computer (not shown).

FIG. 2 shows a prior art method of installing a DSL transmitter 10. The communication line between the central office and the consumer is broken, and a splitter 12 is inserted in series with the line. A DSL transmitter 10 is then coupled to the splitter 12, to provide DSL signals onto the communication line. This prior art method of manually inserting splitters and DSL transmitters, however, is clumsy and time-consuming.

### BRIEF DESCRIPTION OF THE DRAWINGS

FIG. 1 shows a prior art setup between a telephone central office and a consumer's home.

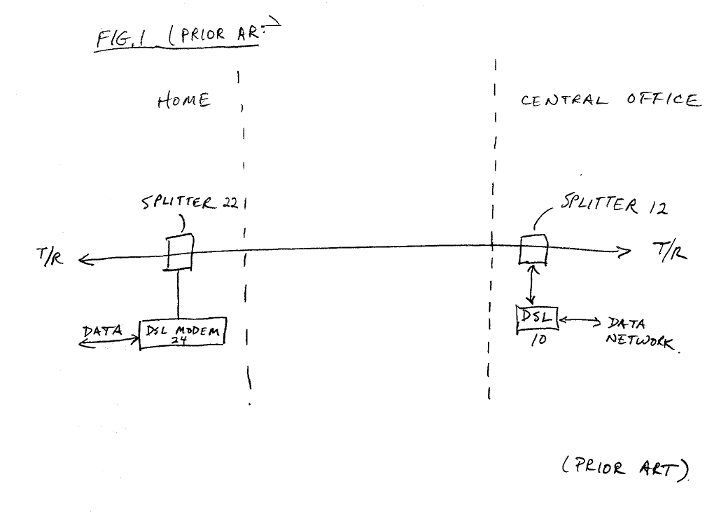

FIG. 2 shows a prior art method of installing a DSL transmitter.

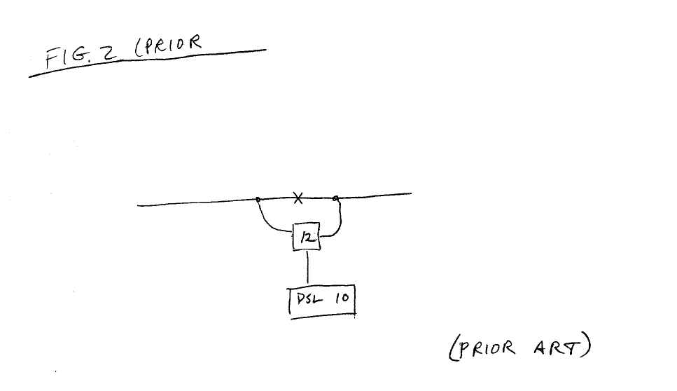

FIG. 3 shows one system for providing DSL service that also provides plain old telephone service (POTS).

FIG. 4 shows an example of a passive splitter on one or more transition cards.

### DETAILED DESCRIPTION

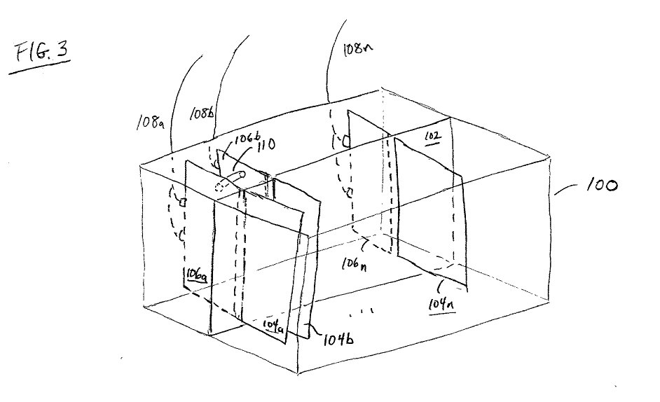

FIG. 3 shows one system for providing DSL service that also provides plain old telephone service (POTS). Chassis 100 contains midplane 102. Midplane 102 is a circuit board that provides sockets for plug-in cards such as main cards 104a-n and transition cards 106a-n to plug into. Unlike a standard chassis system in which all cables are passed through the chassis directly to the network card, a midplane system uses transition cards that allow for easy loading and removal of network (main) cards without having to tamper with the cabling and the assembly of the system.

Main cards 104a-n contain active electrical components, such as processing engines, and have a higher failure rate than passive components. Conversely, transition cards 106a-n contain primarily passive electrical components (e.g., resistors, capacitors, inductors) and mostly provide Input/Output (I/O) termination; transition cards have a lower failure rate than the main cards. This deliberate separation of functionality is an attempt to maintain a high level of fault tolerance for the midplane system. More specifically, replacing a transition card 106a-n likely involves reconfiguring I/O and rearranging physical cabling, which are both time-consuming and susceptible to errors. Therefore, implementing a transition card 106a-n with a low failure rate is likely to result in infrequent changes of the card and a reduced probability of encountering undesirable delays and errors that are associated with the card changes. On the other hand, unlike a transition card 106a-n, swapping out a main card 104a-n does not involve the mentioned reconfiguration and rearrangement. Thus, placing core processing on an easily exchangeable network communication card, such as main card 104a-n, helps to avoid disrupting operations of the system.

Referring to FIG. 3, a transition card 106a is coupled to network I/O 108a via cable interfaces. Transition card 106a is also coupled to main card 104a via the midplane 102 which allows I/O signals to be passed through from one side to the other. Midplane 102 also allows some signals to be routed to other transition or main cards plugged into the chassis 100. In one embodiment, connectors 110 between transition cards may also be employed so that common signals are provided between transition cards. Similarly, transition card 106b is coupled to main card 104b via the midplane 102, and so forth. Transition card 106b may also be connected to network I/O 108b.

In one embodiment, each of the main cards 104a-n communicate via a Compact PCI (cPCI) bus. (The cPCI specification is published by the PCI Industrial Computers Manufacturer's Group.) The cPCI bus allows the main card to be hot-swapped, i.e., removed and replaced without the need to power down the chassis 100.

In one embodiment, a multi-slot transition card supports the passive splitting function that separates the high frequency DSL signals from the low frequency subscriber line interface card (“SLIC”) signals used in POTS. The separated signals are then brought to the midplane and routed to separate card slots on separate connectors. Independent DSL and SLIC main cards, installed in pairs or sets, contain the electrical interfaces for providing DSL and POTS services, respectively. Utilizing the transition card, the active DSL and SLIC cards are easily removable and can be replaced in the event of a failure without requiring the shutdown of the entire chassis.

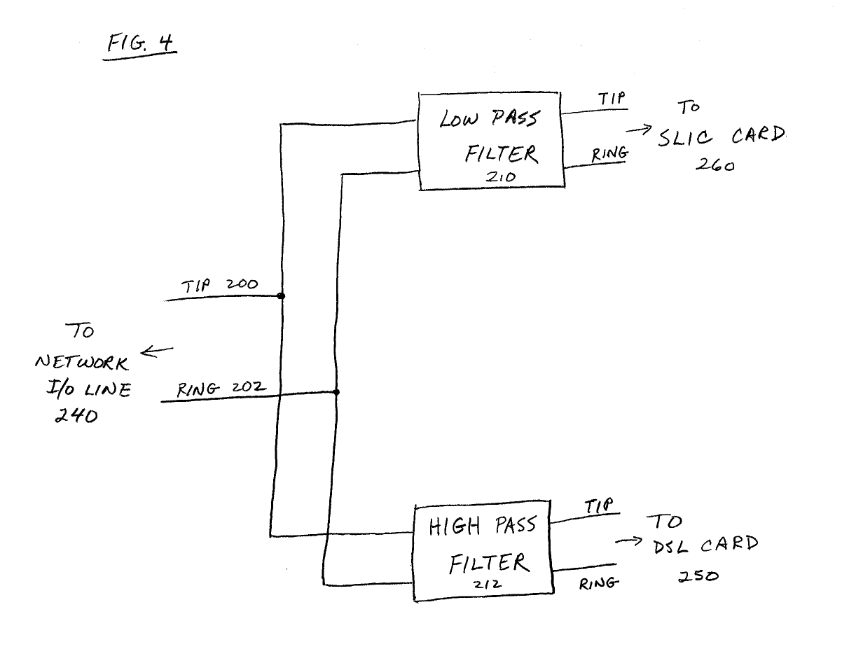

FIG. 4 shows an example of a passive splitter that may be implemented on one or more transition cards coupled to a DSL main card 250 and a SLIC main card 260. Tip 200 and Ring 202 signals from a network I/O line 240 are coupled to both a low pass filter 210 and a high pass filter 212. The low pass filter 210 allows the tip and ring signals to be bi-directionally communicated between the network I/O line 240 and the SLIC main card 260. The high pass filter 212 allows the tip and ring signals to be bi-directionally communicated between the network I/O line 240 and the DSL main card 250.

In one embodiment, the passive components are limited to the transition cards. Active components are placed on main cards. For example, the DSL transmitter 230 is located on a DSL main card, and the SLIC transmitter is located on a SLIC main card.

In one embodiment, multiple DSL main cards and/or multiple SLIC main cards are combined to provide additional DSL and POTS services to a single network I/O line.

Thus, a method of providing digital subscriber line service is described. However, the specific embodiments and methods described herein are merely illustrative. Numerous modifications in form and detail may be made without departing from the scope of the invention as claimed below. For example, although the above description uses the term “DSL” services, these services are also meant to include asynchronous digital subscriber line (ADSL) services as well as other forms of digital subscriber line services. The invention is limited only by the scope of the appended claims.

What is claimed is:

1. A method of providing a digital subscriber line service and a plain old telephone service comprising:
connecting a communication I/O line to a chassis;
providing the digital subscriber line service onto the communication I/O line using a first circuit board in the chassis; and
providing the plain old telephone service on the communication I/O line using a second circuit board in the chassis.

2. The method of claim 1 further comprising:
providing digital subscriber line service onto the communication I/O line using a hot-swappable first circuit board.

3. The method of claim 2 further comprising:
providing plain old telephone service onto the communication I/O line using a hot-swappable second circuit board.

4. The method of claim 3 further comprising:
using one or more transition circuit boards to provide a splitting function of separating first signals used for providing the digital subscriber line service from second signals for providing the plain old telephone service.

5. The method of claim 4 further comprising:
using a low pass filter on the one or more transition circuit boards to filter out the first signals used to provide the digital subscriber service; and
using a high pass filter on the one or more transition circuit boards to filter out the second signals used to provide the plain old telephone service.

6. A method of splitting digital subscriber line (DSL) signals and subscriber line interface card (SLIC) signals comprising:
using passive components to separate the DSL signals and the SLIC signals;
providing the DSL signals to a first circuit board; and
providing the SLIC signals to a second circuit board.

7. The method of claim 6, wherein the first circuit board and the second circuit board are plugged into a first side of a midplane circuit board, and wherein the passive components are on a transition circuit board plugged into a second side of the midplane circuit board.

8. The method of claim 7, wherein the first circuit board and the second circuit board are hot-swappable.

9. The method of claim 8, wherein a network data line is attached to the transition circuit board.

10. The method of claim 6 further comprising:
using a low pass filter to provide the SLIC signals to the second circuit board; and
using a high pass filter to provide the DSL signals to the first circuit board.

11. The method of claim 10, wherein the low pass filter and the high pass filter are on a transition circuit board.

12. The method of claim 11, wherein the transition circuit board is plugged into one side of a midplane circuit board and the first circuit board and the second circuit board are plugged into a second side of the midplane circuit board.

13. The method of claim 12, wherein the first circuit board and the second circuit board are hot-swappable.

14. A method of handling digital subscriber line (DSL) signals and subscriber line interface card (SLIC) signals comprising:
receiving the DSL signals and the SLIC signals;
separating the DSL signals from the SLIC signals in one or more transition cards having primarily passive components;
providing the DSL signals to a first hot-swappable circuit board;
providing the SLIC signals to a second hot-swappable circuit board.

15. The method of claim 14 further comprising:
plugging the first hot-swappable circuit board and the second hot-swappable circuit board into a first side of a midplane board.

16. The method of claim 15 further comprising:
plugging the one or more transition cards into a second side of the midplane board.
